(19) United States
(12) Patent Application Publication
(10) Pub. No.: US 2004/0002789 A1
(43) Pub. Date: Jan. 1, 2004

(54) Loss-in-weight feeder with discharge pressure compensator

(76) Inventor: Robert George Hachtel, Cordova, TN (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/188,172

(22) Filed: Jul. 1, 2002

(51) Int. Cl. G06F 17/00

(52) U.S. Cl. 700/241

(57) ABSTRACT

An improved loss-in-weight feeder, and methods for its use, having a material delivery system, a weight-sensing device for material input, a mass flow control mechanism which adjusts flow to a designated rate in response to changes in weight units of material per time or total weight being processed, and a discharge outlet, wherein the improvement comprises a discharge pressure compensator flexibly connected to the discharge outlet, said feeder being especially advantageous when discharging into nonambient pressure systems to improve reliability in performance, feed rate accuracy, and minimize feeder disturbances, allowing tight control and reduced variability of feed rates are disclosed.

### FIELD OF THE INVENTION

The present invention relates to a loss-in-weight mass flow system with improved performance for controlling the discharge of solid materials in systems which experience fluctuations which disturb the weight measurement.

### BACKGROUND OF THE INVENTION

Loss-in-weight feeders are in general use in industrial processes for mass flow metering of bulk solids. Such feeders are precision gravimetric devices that operate on the principle of weight loss over a period of time to generate a mass flow rate based on an established setpoint. To achieve accuracy, the feeder is suspended on a high resolution scale mechanism (weight-sensing device). The material to be fed is continuously or intermittently weighed as the material is delivered and the weight is converted to an electrical signal used to indicate the rate at which the fed material is decreasing. This is compared with a setpoint representing the desired rate of feed and adjustments are made in the rate of feed, thereby maintaining delivery at the desired rate.

For particularly dusty and/or hazardous material or material for use in food grade or pharmaceutical applications, it may be desired or even required to keep material in a closed system. In such systems, the feeder is isolated from other connected equipment so that the feeder is freely suspended on its scale mechanism for accurate weight loss measurement.

For loss-in-weight feeders discharging into closed systems, especially nonambient pressure environments such as in processes operated under pressure or vacuum, very small pressure fluctuations (for example, less than 1 inch (2.54 cm) H₂O pressure fluctuations) can act with a resultant force that disturbs the scale weight measurement causing a false feed rate measurement and variability in the accuracy of the feeding device. These pressure fluctuations occur as pressure pulses that affect the feeder's instantaneous weight measurement by typically exerting a vertical upward, or alternatively, downward force on the weight-sensing device causing the weight measurement to falsely read less or more. The false reading creates a weight loss rate change; the feeder controller senses that too much or too little material is being discharged from the feeder. To compensate, the feeder controller decreases or increases the speed to meet the setpoint, discharging less or more material per unit time. The result is inaccurate mass flow metering and feed rate variability during these disturbances.

Feed rates are particularly critical in continuous applications where the feeder is in ratio control to one or more other flow variables. False feed rates can also cause mass flow variability problems in batch applications.

Previous efforts have been directed at the problem of false measurements when accurate weight measurements are needed in a closed system. Several of these efforts have utilized algorithms in the weight control system and the electronics of the feeder to recognize the disturbance and adjust controller action. See, for example, U.S. Pat. No. 4,054,784. However, these attempts have not eliminated the root cause of the problem. Other attempts to overcome the problem of false weight measurements due to pressure pulses include providing a sock at the feeder discharge outlet to vent pressure disturbances. However, socks tend to become plugged and thus any advantage is lost. Furthermore, depending on the nature of the material being conveyed, there may be safety and/or environmental concerns if a sock is used.

Another alternative to compensate for the pressure fluctuations has been to create a vent in the system wherein the vent is connected to a constant pressure source and provides a dust collection system. For example, a vent can be placed along the discharge chute or in downstream equipment. Problems associated with this alternative are that dust collection systems tend to be expensive to operate and maintain and the dust collection system itself may experience intermittent pressure fluctuations that further disturb the feeder weight-sensing and gravimetric operation. Furthermore, the vent pipes may plug and stop venting the pressure disturbances.

Therefore, there remains a need for an improvement in loss-in-weight feeders, especially for those used in closed systems, to render them impervious to disturbances such as variations in downstream pressure. It is further desirable for a loss-in-weight feeder that will not be expensive to operate and will provide improved accuracy, especially in continuous operations where feed rate variability cannot be tolerated. The present invention meets these needs.

### SUMMARY OF THE INVENTION

The present invention comprises an improved loss in weight feeder having a material delivery system, a weight-sensing device for material input, a mass flow control mechanism which adjusts flow to a designated rate in response to changes in weight units of material per time or total weight being processed, and a discharge outlet, wherein the improvement comprises a discharge pressure compensator flexibly connected to the discharge outlet.

The present invention further comprises a method for adding a material to a process comprising discharging the material from an improved loss in weight feeder having a material delivery system, a weight-sensing device for material input, a mass flow control mechanism which adjusts flow to a designated rate in response to changes in weight units of material per time or total weight being processed, and a discharge outlet, wherein the improvement comprises a discharge pressure compensator flexibly connected to the discharge outlet.

The present invention further comprises a method for counterbalancing forces resulting from downstream disturbances in a closed process into which material is metered by loss-in-weight from a delivery system comprising adding a discharge pressure compensator flexibly connected to a discharge outlet of the delivery system.

The present invention further comprises a method for decreasing feed rate variability of a loss-in-weight feeder comprising adding a discharge pressure compensator flexibly connected to a discharge outlet of the feeder.

The improved loss-in-weight feeder and methods of the present invention are useful in any process where there is a need for accurate metering of material within a closed system. The improved feeder and methods are particularly useful for processes which are susceptible to pressure fluctuations, such as those where there is a nonambient pressure system. In such systems, the feeder and methods are especially advantageous in providing improvement in reliability in performance, feed rate accuracy, minimizing feeder disturbances, and allowing tight control and reduced variability of feed rates. The improved feeder and methods are useful in a variety of industries wherein a weigh feeding system is employed. A few examples include plastics (including additives such as pigments, anti-oxidants), food (for example, making peanut butter, candy, bread, vitamin-fortified flour), chemicals (detergents, pigmenting processes), pharmaceuticals, cement and building materials.

### BRIEF DESCRIPTION OF THE FIGURES

FIG. 1 is a diagram of a loss-in-weight feeder in accordance with the present invention.

FIG. 2 is a diagram of a loss-in-weight feeder in accordance with the prior art.

### DETAILED DESCRIPTION OF THE INVENTION

The present invention provides an improved loss-in-weight feeder having a discharge pressure compensator. It is especially useful in closed systems, and is used in continuous mass flow rate feeding application or totalized bath feeding application. It is particularly useful in continuous operation. The feeder is particularly suitable for accurate and reliable metering of solids. The feeder is advantageously useful in processes wherein the solids that are fed have high dust tendencies and/or comprise hazardous materials. Such loss-in-weight feeders have applicability where the ratio of additives to chemical or blending operations must be tightly controlled. In addition, the feeder has particular use in the food and pharmaceutical industries where closed systems are important to prevent contamination and to meet USDA and FDA standards. The feeder is useful for continuous or batch feeding into closed systems.

Loss-in-weight feeders are generally available commercially from manufacturers such as Acrison, Inc. (Moonachie, N.J.), K-Tron Soder (Pitman, N.J.), Merrick Industries (Lynn Haven, Fla.), and Schenk AccuRate (Whitewater, Wis.). Any of these can be modified in accordance with the present invention.

Generally the improved loss-in-weight feeder of the present invention comprises a material delivery system, a weight-sensing device for material input, a mass flow control mechanism which adjusts flow of material to a designated rate in response to changes in weight units of material per time and/or total weight being processed, and a discharge outlet, wherein the improvement comprises a discharge pressure compensator flexibly connected to the discharge outlet.

The material delivery system of the feeder comprises any suitable feeding device for effecting discharge of the material in a controllable manner. One embodiment comprises a container, such as a feeder or hopper, for prefilling with the material or substance to be delivered, having a means for feeding the substance from the container, such as a screw feeder, auger, pump, belt, valve, or louvered or vibratory pan to a feeder discharge outlet. The feeding is controlled by a motor, computer, or other such device, to propel the substance through the system. Optionally there is a refill feeder system which automatically feeds material at a controllable rate into the material delivery system to maintain the supply of material therein within preselected limits. Preferably there is a refill feeder system to allow for continuous operation. See, for example, U.S. Reissue 32,101, U.S. Reissue 32,102, and U.S. Pat. No. 4,320,855.

The weight-sensing device of the feeder comprises a means for weighing the material being delivered, and means coupled thereto for producing electrical signals proportional to its weight. Any conventional weight-sensing device can be used in the present invention, which produces electrical signals proportional to the weight of a container and its contents. Suitable devices include a scale, load cell, counterbalanced weighing mechanisms, or other means based upon linear variable differential transformers.

The mass flow control mechanism comprises a means for receiving the electrical signal, comparing it to a setpoint standard or to the total feed weight to be added, computing an error or corrective signal based on the comparison, and generating one or more output signals for adjusting the rate of flow in the material delivery system in response to changes in weight units of material per time and/or total weight being processed. The mass flow control mechanism is typically a computer system including relevant hardware, software and algorithms which allow for display of the data, input for system controls and adjustments, as well as warning indicators to keep operators informed. Such systems are known in the art. The flow control mechanism preferably controls the feed rate or flow at a constant value.

The discharge outlet comprises a conduit for the substance to exit the loss-in-weight feeder. The outlet is of a material, shape and size compatible with the material delivery system. In the present invention, it is connected to a discharge pressure compensator, and to a separate discharge chute or conduit which conveys the substance to the next step or phase of the overall process.

In the improved loss-in-weight feeder of the present invention, a discharge pressure compensator is used. The discharge pressure compensator comprises a closed fitting flexibly connected to the discharge outlet and mounted to a stationary support. It is typically a closed end cap and is mounted to the stationary support independently of the material delivery system and weight-sensing device. Thus fluctuations, such as pressure variations in a closed system, which would usually disturb the measurement of the weight of material being processed by the material delivery system, are instead transferred to and absorbed by the discharge pressure compensator leaving the weight measurement unaffected. The discharge pressure compensator provides a method to counterbalance forces resulting from such fluctuations.

The discharge pressure compensator is made from one or more of a variety of suitable materials. Examples of suitable materials include, but are not limited to, metals, plastics, polymers, woods, stone, concrete, ceramics, or mixtures thereof. The size or shape of the fitting can vary and is made appropriate to the specific process and equipment employed therein, so long as it has a flexible connection to the discharge outlet and is mounted to a stationary support. The connection to the stationary support is inflexible. When the embodiment is a closed end cap, it is flat or round at its end and can vary in length. Typically, it is less than 24 inches (61 cm) in length, preferably less than 12 inches (30.5 cm) in length, and has a diameter comparable to the discharge outlet, conduit or chute leading to the next phase of the process. The function of the discharge pressure compensator is to maintain the discharge of the material delivery system as a closed system by flexible connection to the discharge outlet and to transmit forces resulting from fluctuations, such as pressure variations, to the stationary support independent of the weight-sensing device and material delivery system.

The connections between the discharge outlet and the discharge pressure compensator, and between the discharge outlet and the discharge chute are flexible. A variety of flexible sleeves are suitable for use herein and are made of a substance chosen to be suitable for contact with the material being processed. The sleeves are usually made of finely woven cloth, polymer or copolymer. Examples include nylon, cotton, polyester, polyolefin, polytetrafluoroethylene, polyvinyl chloride, and mixtures and copolymers thereof. The sleeves can be coated or impregnated for chemical resistance and dust containment within the system. The flexibility is required in order to isolate the movement of the discharge outlet from the material delivery system and weight-sensing device, and from the discharge chute or conduit. The sleeves are connected by adhesive, band clamp, or strap material suitable for such attachments. Preferably the flexible sleeves are continuously connected in a manner to provide a sealed or closed system which is not open to the atmosphere. The size of the sleeves is that which fits the specific equipment employed. The sleeves are typically less than 24 inches (61 cm) in length, preferably less than 12 inches (30.5 cm) in length.

For maximum performance, the flexible sleeves attached to the discharge outlet are of about equal or comparable cross sectional area. The connections to the discharge chute and the discharge pressure compensator are on different sides of the discharge outlet. For maximum performance the flexible sleeves are preferably connected to opposite sides of the discharge outlet and oriented 180 degrees to each other.

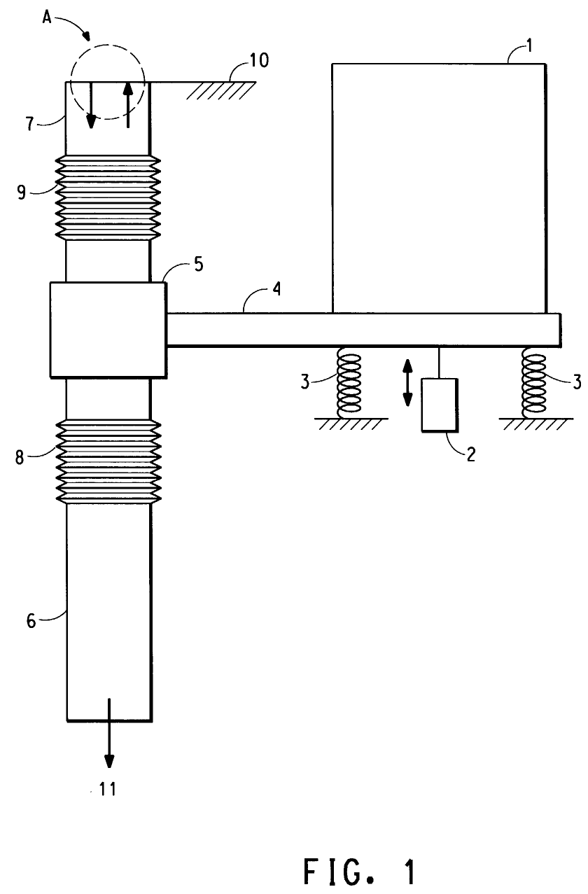

One embodiment of the improved feeder of this invention is described with reference to FIG. 1. FIG. 1 illustrates diagrammatically an improved loss-in-weight feeder. The material delivery system comprises a hopper 1 in which the material or substance to be fed is filled, and a feed apparatus 4 for discharge of the material. An optional automatic refill system to maintain a preselected amount of material in the material delivery system is not shown.

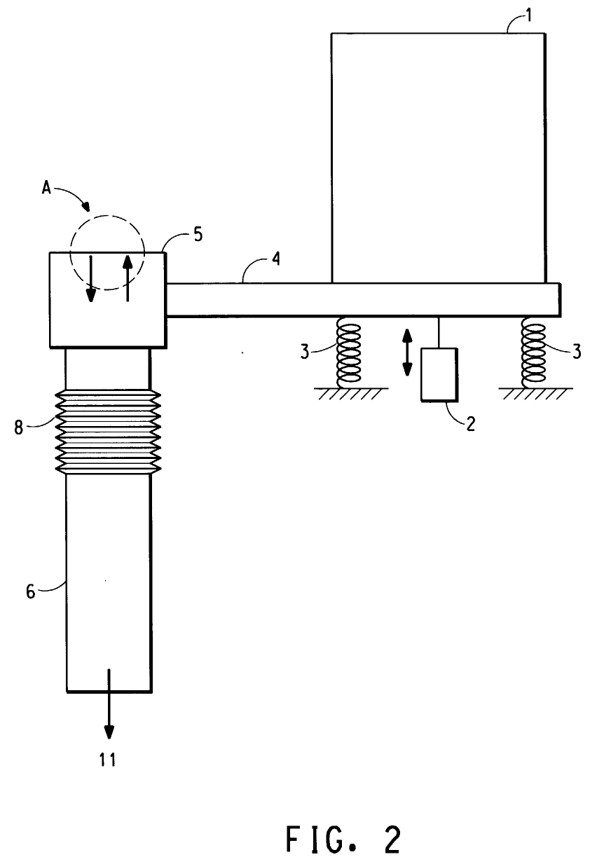

There is further provided a weight-sensing device 2 for measuring the weight of the material being discharged by measuring the weight of the hopper of the material delivery system and the material therein to be discharged. The weight delivered is determined by difference. Any conventional weight-sensing device is used in the present invention, which produces electrical signals proportional to the weight of a hopper plus material therein. The weight-sensing device can be a scale, but typically includes load cells 2, as illustrated in FIG. 1, or other means based on linear variable differential transformers (LVDTs) or counterbalanced weighing mechanisms. High resolution load cells are the preferred weight-sensing device. Although in FIGS. 1 and 2 the weight-sensing device is shown below hopper 1, the hopper could also be suspended from a support frame, and the weight-sensing device could be positioned above the hopper. The load cells act together with spring(s) 3 in response to weight loss or gain. The weight-sensing device produces a signal which corresponds to the weight measurement. The weight of the material in the hopper is continuously measured, or measured at intervals that are for practical purposes continuous.

Coupled to the weight-sensing device is a mass flow control mechanism (not shown) which accepts the signal conveyed from the weight-sensing device and compares the signal to a setpoint. The setpoint may be a feed rate to a process or, alternatively, a total feed weight to be fed to a process. Advantageously, the flow control system controls the feed rate of material at a constant value. In addition or alternatively, especially for batch operations, the flow control system can compare the signal with the total feed weight to be added. Components of flow control systems, including computer hardware, software, and algorithms applicable to the loss-in-weight feeder of the present invention are well known in the art. See for example, U.S. Pat. No. 4,320,855 (and its reissues Re. 32,101 and Re. 32,102); U.S. Pat. Nos. 4,762,252; 4,579,252 and 5,103,401.

Material flows from hopper 1 to a feeder apparatus 4 which is any conventional material feeder apparatus, such as a screw feeder or auger, or any suitable device such as a belt, rotary valve, louvered or vibratory pan, for effecting discharge of material in a controllable fashion. Typically feeder apparatus 4 will be a screw feeder. Feeder apparatus 4 is driven by a suitable motor, not shown. The motor receives a signal from the flow control system in response to the comparison of the setpoint to the signal from the weight-sensing device to control (i.e., increase or decrease) the rate at which material is discharged from the hopper.

The material flows from feeder apparatus 4 to a feeder discharge outlet 5. From discharge outlet 5, the material passes into a discharge chute 6. Discharge outlet 5 is flexibly connected in a sealed relationship to a discharge pressure compensator comprising a capped end fitting 7. Discharge outlet 5 is also flexibly connected at another side, preferably a side opposite to its connection to the discharge pressure compensator, in a sealed relationship to a discharge chute 6. Flexibility is typically provided by flexible sleeves shown at 8 and 9. Preferably the flexible connections 8 and 9 are of equal size in cross sectional area.

The capped end fitting 7 is mounted to a stationary support 10, which completes the discharge pressure compensator. Capped end fitting 7 is supported on stationary support 10 independently of the delivery system 4, hopper 1, and weight-sensing device 2.

From the discharge chute 6, the material passes to the next step or phase of the overall process indicated by arrow 11. The process includes operations such as mixing or blending, chemical processes, chemical reactions or conveying operations.

Point A, illustrated by the arrows within a circle, indicate that forces, typically upward or downward, which result from a disturbance in the process, such as a downstream pressure variation, are transferred to the stationary support 10 instead of to feeder apparatus 4. Thus the feeder weight measurement as well as the computed feeding rate is unaffected by the force and the feeding rate more uniform.

FIG. 2 illustrates diagrammatically a typical loss-in-weight feeder of the prior art. The numbers correspond to those components as indicated for FIG. 1. Noticeably absent in FIG. 2 is the discharge pressure compensator comprising capped end fitting 7 and stationary support 10, and the flexible connection between discharge outlet 5 and the discharge pressure compensator. Thus at Point A, forces, typically upward or downward, which result from a disturbance in the process, such as a downstream pressure variation, are transferred to feeder apparatus 4 thereby affecting the feeder weight measurement and the computed feed rate.

The present invention further comprises a method for adding a material to a process comprising discharging the material from an improved loss in weight feeder as described above having a discharge pressure compensator. The method of the present invention can be used in any process where there is a need for accurate metering Qf material, particularly for closed system processes which are susceptible to pressure fluctuations, such as those within a nonambient pressure system. The method is suitable for use in both continuous mass flow rate feeding application and totalized batch feeding application. The method of the present invention is especially useful in a continuous mass flow feeding operation because it provides improvement in feed rate accuracy, minimizes feeder disturbances, and permits tight control and reduced variability of feed rates. The improved accuracy of the method of the present invention is particularly advantageous in processes where the feeder is in ratio control to one or more other flow variables.

The present invention further comprises a method for counterbalancing forces resulting from downstream disturbances in a closed process into which material is metered by weight from a delivery system comprising adding a discharge pressure compensator flexibly connected to a discharge outlet of the delivery system. In this method, the delivery system comprises an improved loss-in-weight feeder as previously described above having a discharge pressure compensator. The discharge pressure compensator is as detailed previously and is mounted to a stationary support and flexibly connected to the discharge outlet, which outlet is flexibly connected to a discharge chute or conduit for conveyance of the material to the next step or phase of the process. The process disturbances are typically downstream pressure variations or other such disturbances that adversely affect the weight measurement of the delivery system. The forces resulting from the downstream disturbance are transferred to and counterbalanced by the discharge pressure compensator thereby leaving the weight measurement unaffected.

Although pressure fluctuations have been used to exemplify the type of process disturbance herein, it is recognized that the source of the process disturbance is unimportant. So long as the disturbance is one that disrupts accurate weight measurement and can be absorbed by the discharge pressure compensator, the advantages of the improved loss in weight feeder and the methods of the present invention will be realized.

The present invention further comprises a method for decreasing feed rate variability of a loss-in-weight feeder comprising adding a discharge pressure compensator flexibly connected to a discharge outlet of the feeder. Commercially available feeders, as well as those already in use in a process, can be modified using the present invention to improve feed rate accuracy by decreasing variability due to disturbances in weight measurement. A discharge pressure compensator as described above is added to the feeder. The discharge pressure compensator is mounted to a stationary support, and is flexibly connected to the discharge outlet of the feeder as previously described. The discharge outlet is flexibly connected to a discharge chute or conduit for conveyance of the material to the next step or phase of the process. The flexible connections are of the type and size described above and are positioned as described above.

The present invention solves a feeding accuracy problem common to all types of loss-in-weight feeders that are applied in closed process systems. It is inexpensive and easily adapted to any model of loss-in-weight feeder. The present invention is simple in design, completely passive, requires no maintenance other than normal flexible sleeve replacement, and avoids the need for expensive equipment to provide venting to a constant pressure source. It can be adapted to existing feeder applications experiencing the problems described, or supplied as an optional accessory to improve feed rate accuracy in new feeder applications. Commercially available feeders can be modified according to the invention to provide the benefits achieved herein.

### EXAMPLE

In a process to produce crystals containing potassium monopersulfate according to U.S. Pat. No. 4,579,725, an aqueous mixture of H₂SO₅ and H₂SO₄ was partially neutralized with an aqueous solution of potassium hydroxide. The resulting mixture was a slurry with crystals containing active component KHSO₅. The crystals were separated and dried. A discharge pressure compensator was installed on an Acrison model 402-200-100-BDF1.5-F loss-in-weight feeder to yield a feeder as shown in FIG. 1. The crystals were blended with magnesium carbonate powder at a relative target ratio of 1:1, wherein the magnesium carbonate was added to the crystals by means of a loss-in-weight feeder as shown in FIG. 1.

### Comparative Example

The process of the example was repeated with addition of the magnesium carbonate using a conventional loss-in-weight feeder as shown in FIG. 2. The magnesium carbonate was added at a relative target ratio of 1.43:1 to compensate for disturbances. The disturbances resulted in feed rate variability and periods of under-feeding to the process. Comparisons are provided in the Table 1.

TABLE 1

| Parameter | Example | Comp. Ex. |
|---|---|---|
| Average | 0 | 3-6 |
| disturbance/day | | |
| Relative target ratio | 1 | 1.43 |
| Relative standard | 1 | 1.88 |
| deviation of ratio | | |

As can be seen from the Table, use of the feeder of this invention provided improved performance by eliminating the disturbances to the feeder. In addition, because disturbances were eliminated in the Example, controls were set at lower values, which reduced use of reagents, thereby reducing manufacturing costs and reducing product impurities. The improved feeder further allowed tighter control around the target ratio, as indicated by the lower standard deviation.

What is claimed is:

1. An improved loss-in-weight feeder having a material delivery system, a weight-sensing device for material input, a mass flow control mechanism which adjusts flow of material to a designated rate in response to changes in weight units of material per time or total weight being processed, and a discharge outlet, wherein the improvement comprises a discharge pressure compensator flexibly connected to the discharge outlet.

2. The feeder of claim 1 wherein the discharge pressure compensator comprises a closed end fitting connected with flexible sleeves to the discharge outlet.

3. The feeder of claim 2 wherein the discharge pressure compensator is connected to a stationary support independent of the weight-sensing device.

4. The feeder of claim 3 further comprising a discharge chute flexibly connected to the discharge outlet by flexible sleeves.

5. The feeder of claim 4 wherein the flexible sleeves connecting the discharge pressure compensator to the discharge outlet and the flexible sleeves connecting the discharge outlet to the discharge chute are of about equal size in cross sectional area.

6. The feeder of claim 5 wherein the flexible sleeves are continuously connected to provide a closed system.

7. The feeder of claim 6 wherein the flexible sleeves connecting the discharge pressure compensator to the discharge outlet and the flexible sleeves connecting the discharge outlet to the discharge chute are located on different sides of the discharge outlet.

8. The feeder of claim 7 wherein the flexible sleeves connecting the discharge pressure compensator to the discharge outlet and the flexible sleeves connecting the discharge outlet to the discharge chute are located on opposite sides of the discharge outlet.

9. The feeder of claim 1 in continuous mass flow rate feeding application or in totalized batch feeding application.

10. A method for adding a material to a process comprising discharging the material from an improved loss-in-weight feeder having a material delivery system, a weight-sensing device for material input, a mass flow control mechanism which adjusts flow of material to a designated rate in response to changes in weight units of material per time or total weight being processed, and a discharge outlet, wherein the improvement comprises a discharge pressure compensator flexibly connected to the discharge outlet.

11. A method for counterbalancing forces resulting from downstream pressure disturbances within a closed process into which material is metered by loss in weight from a delivery system comprising adding a discharge pressure compensator flexibly connected to a discharge outlet of the delivery system.

12. A method for decreasing feed rate variability of a loss-in-weight feeder comprising adding a discharge pressure compensator flexibly connected to a discharge outlet of the feeder.

13. The method of claim 10, 11 or 12 wherein the discharge pressure compensator comprises a closed end fitting connected with flexible sleeves to the discharge outlet.

14. The method of claim 13 wherein the discharge pressure compensator is connected to a stationary support independent of the weight-sensing device.

15. The method of claim 14 further comprising a discharge chute flexibly connected to the discharge outlet by flexible sleeves.

16. The method of claim 15 wherein the flexible sleeves connecting the discharge pressure compensator to the discharge outlet and the flexible sleeves connecting the discharge outlet to the discharge chute are of about equal size in cross sectional area.

17. The method of claim 16 wherein the flexible sleeves are continuously connected to provide a closed system.

18. The method of claim 17 wherein the flexible sleeves connecting the discharge pressure compensator to the discharge outlet and the flexible sleeves connecting the discharge outlet to the discharge chute are located on different sides of the discharge outlet.

19. The method of claim 18 wherein the flexible sleeves connecting the discharge pressure compensator to the discharge outlet and the flexible sleeves connecting the discharge outlet to the discharge chute are located on opposite sides of the discharge outlet.

20. An improved loss-in-weight feeder having a material delivery system, a weight-sensing device for material input, a mass flow control mechanism which adjusts flow of material to a designated rate in response to changes in weight units of material per time or total weight being processed, a discharge outlet, and a discharge chute, wherein the improvement comprises a discharge pressure compensator formed as a closed end fitting connected to a stationary support independent of the weight-sensing device, said discharge pressure compensator continuously connected by flexible sleeves to one side of the discharge outlet, said discharge outlet continuously connected on an opposite side by flexible sleeves of about equal cross sectional area to a discharge chute.
